(19) United States
(12) Patent Application Publication
(10) Pub. No.: US 2025/0180752 A1
(43) Pub. Date: Jun. 5, 2025

(54) Optically Scanning Sensor

(71) Applicant: SICK AG, Waldkirch (DE)

(72) Inventors: Patrick STEIN, Bad Krozingen (DE); Markus HAMMES, Freiburg (DE)

(21) Appl. No.: 18/956,805

(22) Filed: Nov. 22, 2024

(30) Foreign Application Priority Data
Dec. 1, 2023 (DE) 10 2023 133 650.9

(51) Int. Cl. G01S 17/95; G01S 17/931

(52) U.S. Cl. CPC G01S 17/95; G01S 17/931

(57) ABSTRACT

An optical scanning sensor comprises a transmission unit, a reception unit and an evaluation unit. The transmission unit is configured to emit a transmission signal into a predetermined scanning zone of the sensor. The reception unit is configured to detect a reflected or remitted portion of the transmission signal and to output a corresponding reception signal. Furthermore, the evaluation unit is configured to detect at least one object in the scanning zone of the sensor based on the reception signal. The scanning zone comprises a partial zone that differs from the remaining scanning zone by at least one characteristic with respect to the transmission signal, the reception signal and/or the evaluation of the reception signal. The evaluation unit is configured to detect interference influences, which hinder the detection of the object, based on a portion of the reception signal that is associated with the partial zone.

The invention relates to an optically scanning sensor comprising a transmission unit for emitting an optical transmission signal into a predetermined scanning zone, a reception unit that detects a reflected or remitted portion of the transmission signal and outputs a corresponding reception signal, and an evaluation unit that is able to detect one or more objects in the scanning zone of the sensor based on the reception signal.

Such optically scanning sensors can be used at machines or at driverless transport systems, such as autonomously driving vehicles, to recognize safety-relevant objects or persons in the environment of the machine or the transport system, for example possible collision objects of the autonomously driving vehicle. Control parameters of the machine or the transport system, such as its speed, can be adapted accordingly if the optically scanning sensor recognizes such safety-relevant objects or persons in the environment of the machine or the transport system.

In contrast to an indoor use, i.e. in closed rooms, such machines or driverless transport systems are exposed to weather influences outdoors that are inevitably present, that cannot be controlled and that are very relevant for the productive sequence in a logistics or production environment of the machine or the transport system.

For an efficient, productive operation of the machine or the transport system, it can be crucial to recognize interferences by adverse weather conditions, such as fog, rain or snow, or due to smoke, dust or foreign objects in the field of view or the scanning zone of the sensor, and to adapt the control parameters of the machine or the vehicle depending on the situation.

Such external influences can limit the mode of operation of optically scanning sensors, such as lidar sensors, with respect to various aspects. The range of the transmission signal can be shortened due to the absorption of a transmission signal of the sensor, for example by droplets of fog or water vapor or by particles. Furthermore, due to such interference influences, detection losses can occur in reception signals that are generated by those transmission signals that are reflected or remitted at objects, for example at safety-relevant persons or collision objects. Furthermore, the fog can, for example, be detected directly instead of objects that are then so-to-say hidden in the fog so that the optically scanning sensor has reduced availability. In addition, fog or water vapor can condense at a front screen of an optically scanning sensor and can thereby reduce the intensity of the transmission and reception signals.

Furthermore, at a certain density, fog may possibly not cause a suitable light echo or reception signal for the optically scanning sensor so that the fog cannot be recognized directly by means of the sensor. In this situation, the fog can nevertheless attenuate the transmission and reception signals of the optically scanning sensor such that a detection of a safety-relevant object can no longer take place, while, at the same time, no detection of the fog takes place, which fog should, for example, lead to a reduction in the speed of a transport system. This is also referred to as a “dangerous failure”. However, the optically scanning sensor should also be able to initiate a suitable measure to avoid the potential danger in situations or under environmental conditions that lead to such a dangerous failure.

An object of the invention consequently comprises providing an optically scanning sensor that is capable of reliably recognizing interference influences during the detection of objects, which interference influences are, for example, caused by adverse weather conditions, in particular fog, or other adverse environmental conditions. Such other adverse environmental conditions relate, for example, to water vapor, smoke or foreign bodies that enter the field of view of the sensor.

This object is satisfied by an optically scanning sensor having the features of claim 1. Advantageous further embodiments of the invention are set forth in the dependent claims, in the description and in the drawings.

The optically scanning sensor comprises a transmission unit, a reception unit and an evaluation unit. The transmission unit is configured to emit an optically scanning transmission signal into a predetermined scanning zone of the sensor. The reception unit is configured to detect a reflected or remitted portion of the transmission signal and to output a corresponding reception signal. Furthermore, the evaluation unit is configured to detect at least one object in the scanning zone of the sensor based on the reception signal.

According to the invention, the scanning zone comprises a partial zone that differs from the remaining scanning zone by at least one characteristic with respect to the transmission signal, the reception signal and/or the evaluation of the reception signal. The evaluation unit is configured to detect interference influences, which hinder the detection of the object, based on a portion of the reception signal that is associated with the partial zone.

The interference influences that may hinder the detection of the object can be, for example, weather influences or environmental conditions that, for example, cause the presence of droplets or particles in the scanning zone of the sensor, e.g. in the form of fog, water vapor, dust or smoke. Such droplets or particles can absorb or scatter light in the scanning zone and can thereby attenuate the transmission signal and the reception signal.

The detection of the interference influences thus takes place by a special treatment of the partial zone within the predetermined scanning zone of the sensor, which partial zone differs from the remaining scanning zone of the sensor with respect to at least one property or characteristic. This property or characteristic relates to the transmission signal, the reception signal and/or the evaluation of the reception signal from the partial zone that differs/differ from the signals or the evaluation for the remaining scanning zone. Such distinguishing characteristics of the partial zone with respect to the remaining scanning zone can, for example, be implemented as follows: The transmission unit can, for example, emit a higher light intensity into the partial zone than into the remaining scanning zone. Alternatively or additionally, the reception unit can have an increased sensitivity with respect to the partial zone, for example by means of separate reception or detection elements for the partial zone. Furthermore, the evaluation unit can evaluate the reception signal that originates from the partial zone in a different way than the reception signal from the remaining scanning zone if the evaluation unit has suitable information about when the sensor scans the partial zone.

Furthermore, information can be transmitted to the evaluation unit that includes when the transmission unit covers or sweeps over the partial zone within the scanning zone that is provided for detecting the interference influences and the optical transmission signal is thus almost exclusively emitted into the partial zone. It can thereby become possible for the evaluation unit to carry out a separate evaluation for the detection of the interference influences based on the partial zone without the transmission signal and/or the reception signal for the partial zone differing from the corresponding transmission and reception signals for the remaining scanning zone. The partial zone can furthermore also be designated as a fog detection zone if fog is to be detected as the main interference influence.

Due to the separate detection of the interference influences in the partial zone of the scanning zone, fog, snow and similar adverse weather conditions can, for example, be reliably detected or recognized. If interference influences are detected, the evaluation unit can then output a corresponding signal, for example in the form of a corresponding bit, that is then used by further apparatus that are connected to the optically scanning sensor.

The optically scanning sensor can, for example, be installed at a transport system, in particular at an autonomously driving vehicle, or at a machine that is provided for the outdoors and is thus exposed to weather influences. Alternatively, an optically scanning sensor according to the invention can also be used indoors to be able to recognize, for example in a chemical production process, when an interference occurs, for example, due to exiting smoke or steam that limits the detection capability of the sensor with respect to objects to be recognized.

Due to the separate detection of the interference influences within the partial zone of the scanning zone, detection losses due to specific environmental conditions can be avoided since the more reliable detection of the interference influences can trigger a change in the parameters for the transmission unit and/or the reception unit so that their configuration can be adapted to fog or weather conditions, for example. The availability of the optically scanning sensor is thereby improved or extended to those situations in which no detection, or an unreliable detection, of interference influences that are possibly associated with detection losses has taken place so far.

If the optically scanning sensor is installed at a transport system or a machine, the predetermined scanning zone can be associated with a protective field for the vehicle or the machine. If, for example, heavy fog is detected, the operation of the vehicle or the machine can be switched to a protection mode with a more robust or reduced protective field, for example due to a reduced speed of the transport system. While a shutdown on the detection of heavy fog is often provided for known machines or transport systems, the vehicle and the machine comprising the optically scanning sensor according to the invention can continue to be operated in the protection mode, for example at a reduced speed, without a complete shutdown being necessary. The productivity of the transport system or the machine can thereby be increased.

Since the partial zone within the scanning zone, for example, only covers a small solid angle range, the detection of the interference influences within the scanning zone does not require a restriction for the entire solid angle range over which the predetermined scanning zone of the sensor extends. In other words, the actual purpose of use of the optically scanning sensor, i.e. the detection of one or more objects within the scanning zone of the sensor, is not restricted by the separate detection of the interference influences.

Due to the separate detection of the interference influences, an enlarged protective field, which is associated with the predetermined scanning zone of the sensor, can further be used since, in contrast to known sensors, at best only a small amount of energy needs to be retained, for example for the detection of fog or the operation in fog. Furthermore, the detection of the interference influences by the evaluation unit is associated with a low computational effort.

According to one embodiment, the transmission signal can cover a respective predetermined geometric shape within the scanning zone at consecutive points in time and this geometric shape can cover the partial zone for detecting the interference influences at at least one predetermined point in time. The optically scanning sensor can, for example, be provided to scan or monitor a specific spatial region in front of the sensor, i.e. can be used as a 3D scanner. The scanning of the spatial region can take place in individual planes or scanning layers that are scanned successively in time or in parallel in time (if a separate transmitter and receiver are used for each layer). As an alternative to individual planes, other types of spatial elements can also be provided for scanning the spatial region or scanning zone, for example individual solid angles or pixels, cylindrical surfaces, conically extending surfaces or Lissajous figures, that thus form the predetermined geometric shape for scanning or sweeping over the predetermined scanning zone.

The partial zone within the predetermined scanning zone that is provided for the detection of the interference influences can thus be defined by one of the aforementioned geometric shapes, for example at one or more predetermined points in time. Since the respective geometric shape and the point in time at which it covers the partial zone or is located within it can be predefined and can thus be known to the evaluation unit, the reliability and robustness of the detection of the interference influences can be further improved.

The transmission signal can sweep over the scanning zone in consecutive scanning layers. In this case, the partial zone can be formed by at least one selected scanning layer. In such an embodiment, the sensor can be operated with little effort since individual scanning layers are predefined, of which at least one scanning layer is selected as the partial zone.

The respective scanning layer can be formed as planar, for example, by first deflecting the transmission signal in the form of a light beam or laser beam in a predefined plane as the first scanning layer and then shifting it by a short distance in a direction perpendicular to the plane of the first scanning layer in order to deflect the light beam or laser beam again within a further plane as the next scanning layer. In this way, the entire scanning zone can be successively scanned.

In practice, however, such a deflection of the light beam or laser beam often does not occur in an ideal plane as a scanning layer. Rather, the surfaces in which the light beam or laser beam is deflected within a scanning layer are conical, for example. When passing through the scanning zone, the curvature of such conically shaped scanning layers can, for example, decrease from a first, uppermost scanning layer down to a middle scanning layer so that this middle scanning layer is planar. During the further scanning, the curvature of the respective scanning layer can, for example, increase again below the middle, planar scanning layer up to the last or lowermost scanning layer.

To define the partial zone, a plurality of scanning layers can also be selected instead of just one. In this case, it is possible to perform the detection of the interference influences for the respective scanning layer and to check the results of such a respective detection of the interference influences for consistency. This can lead to an increased reliability for the detection of the interference influences. The plurality of scanning layers that form the partial zone for detecting the interference influences do not necessarily have to adjoin one another or be arranged adjacently in this respect.

In an alternative embodiment, the various scanning layers of such an optically scanning sensor can be freely configurable. In this case, it can be defined for the respective scanning layer whether it is to be provided for the detection of the interference influences or for the recognition of contours of an object, or even for both.

In a further embodiment, the sensor is attached to an apparatus at a sensor position. In this embodiment, the at least one selected scanning layer that forms the partial zone can be arranged above a horizontal plane that comprises the sensor position and that extends in parallel with a ground plane on which the apparatus is located. The apparatus can in turn be a transport system, for example an autonomously driving vehicle, or a machine that is provided for the outer region. Since the selected scanning layer for the detection of the interference influences extends above the horizontal plane, no unwanted “collision” of the transmission signal with the ground can occur that could possibly lead to interferences in the detection of the interference influences. By selecting the planar scanning layer above the horizontal plane, the reliability of the detection of the interference influences can thus be improved.

In a further embodiment, a separate transmission element or a plurality of separate transmission elements of the transmission unit can be associated with the partial zone. The separate transmission element can be a separate laser or a separate light-emitting diode (LED) of the transmission unit that is provided for the partial zone and emits a separate transmission signal into the partial zone. In this embodiment, the partial zone differs from the remaining scanning zone of the sensor in that the partial zone is supplied with an increased light intensity to be able to detect the interference influences in said partial zone.

Alternatively or additionally, a separate reception element or a plurality of separate reception elements of the reception unit can be associated with the partial zone. The separate reception element can, for example, be a separate avalanche photodiode (APD), in particular a single-photon avalanche diode (SPAD). The separate reception element can further transmit a separate reception signal for the detection of the interference influences to the evaluation unit. Due to this separation of the reception signal with respect to the detection of the interference influences from the further reception signals, the reliability of the detection of the interference influences can be further improved.

The separate reception element of the reception unit that is associated with the partial zone can, for example, also have a greater sensitivity than the further reception elements of the reception unit. The greater sensitivity can be achieved, for example, by providing a greater gain factor or a reduced threshold value for the separate reception element than for the further reception elements of the reception unit. Furthermore, an increased intensity of the light emitted by the transmission unit can again be provided for the separate reception element to detect the interference influences.

In a further embodiment, the evaluation unit can be configured to process the reception signal that is associated with the partial zone by means of specific evaluation steps that are different from the evaluation steps with which the evaluation unit processes the reception signal that is associated with the further regions of the scanning zone outside the partial zone.

The partial zone can thus be assigned a separate evaluation by the evaluation unit, which evaluation is intended to detect the interference influences, while the further regions of the scanning zone can, for example, be provided to generate 3D environmental data or to detect safety-relevant objects.

The detection of fog and other interferences within a scanning zone based on optical signals is described in general in EP 3 435 117 A1 or EP 3 588 139 A1, for example. The detection of the interference influences, such as the detection of fog within the partial zone, can preferably take place based on signatures of a resonant circuit.

The evaluation unit can further be configured to receive an additional checking signal and to check the detection of the interference influences based on the checking signal. The checking signal can be provided by a humidity sensor and/or a dew point sensor, for example. A checking signal of such sensors can be used to check the detection of, for example, fog by means of the optically scanning sensor since fog can only be present at a certain relative humidity, for example from 95% relative humidity. An incorrect detection of interference influences can be avoided through this additional check by means of the checking signal. In other words, the detection of the interference influences by means of the optically scanning sensor can be verified by means of the checking signal before the evaluation unit can output that interference influences are present in the predetermined scanning zone.

The optically scanning sensor can be configured as a lidar sensor, for example. It can be a 2D or 3D lidar system in this respect. As explained above, the interference influences can comprise fog, for example.

The invention further relates to the use of a sensor having the above-described features for detecting interference influences, in particular fog, in a scanning zone of the sensor.

If an apparatus, for example a transport system or a machine, is provided with the above-described optically scanning sensor, its safety-relevant parameters can be adapted based on the detection of interference influences. If interference influences are detected in the scanning zone of the sensor, a configuration of a protective field of the apparatus can be adapted accordingly, or the speed can be reduced in the case of a transport system such as an autonomously driving vehicle.

The invention will be described below by way of example with reference to an advantageous embodiment and to the enclosed Figures. There are shown, schematically in each case:

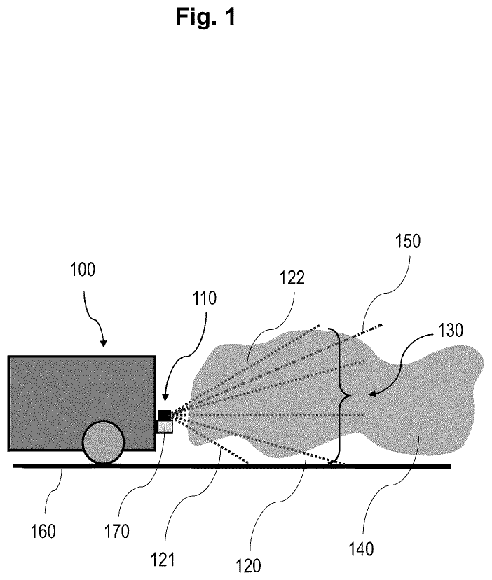

FIG. 1 a representation of a vehicle with an optically scanning sensor according to the invention; and

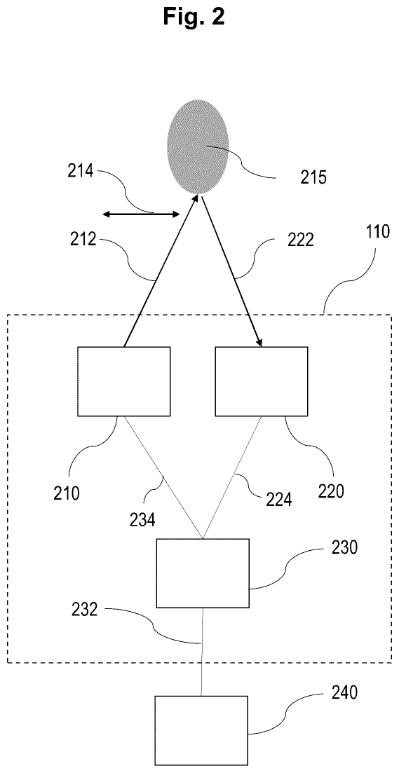

FIG. 2 a block diagram with elements of the sensor of FIG. 1.

FIG. 1 schematically shows a side view of a vehicle 100 to which an optically scanning sensor 110 is attached. The optically scanning sensor 110 is configured as a 3D lidar system here. The sensor 110 comprises a transmission unit 210 (cf. FIG. 2) that emits an optical transmission signal 212 into an outer region of the vehicle 100. The transmission unit 210 is configured as a laser scanner that scans the outer region of the vehicle 100 in a plurality of scanning layers 120 (cf. FIG. 1).

In each scanning layer 120, the laser scanner or the transmission unit 210 scans a specific area that, in relation to the vehicle 100, extends in the transverse direction and, in FIG. 1, perpendicular to the drawing plane. The scanning of the outer region of the vehicle 100 thus takes place, for example, by means of the sensor 110 consecutively in a plurality of planes that extend between a lowermost scanning layer 121 and an uppermost scanning layer 122.

In practice, however, scanning layers 120 are often not ideal planes. Rather, the surfaces in which the light beam or laser beam is deflected within a scanning layer 120 are at least slightly conical. When passing through the scanning zone 130, the curvature of such conically shaped scanning layers 120 decreases from a first, uppermost scanning layer 122 down to a middle scanning layer so that this middle scanning layer is almost planar. During the further scanning, the curvature of the respective scanning layer 120 below the middle, planar scanning layer increases again up to the last or lowermost scanning layer 121.

A scanning zone 130 for the sensor 110 is defined by the finite range of the transmission signal 212 and the angle which the transmission signal 212 sweeps over in the lateral direction within each scanning layer 120, i.e. in the transverse direction to the vehicle 100. The scanning zone 130 is shown in FIG. 1 by a bracket between the uppermost scanning layer 122 and the lowermost scanning layer 121.

The scanning zone 130 is thus a volume in the outer region of the vehicle between the outermost scanning layers 121, 122, which volume is limited in the transverse direction by the angle swept over by the transmission signal 122 in each scanning layer 120.

The primary purpose of use of the sensor 110 is to detect one or more objects 215 (cf. FIG. 2) within the scanning zone 130 or to recognize or map the contour of a respective object 215. The scanning of the contour of the object 215 is indicated in FIG. 2 by the double arrow 214 that extends in the transverse direction in relation to the sensor 110.

A portion of the transmission signal 212 is reflected or remitted at the object 215. This reflected or remitted light 222 is detected by a reception unit 220 of the sensor 110 so that the reception unit 220 outputs a corresponding reception signal 224 and transmits it to an evaluation unit 230 of the sensor 110. Based on the reception signal 224, the evaluation unit 230 determines the contour of the object 215. By means of the evaluation unit 230, the sensor 110 can thus detect the presence of an object 215 within the scanning zone 130 and can determine its spatial shape or contour so-to-say from the perspective of the optically scanning sensor 110.

The information regarding the presence of the object 215 within the scanning zone 130 and regarding its contour is passed on by the evaluation unit 230 in the form of an output signal 232 of the sensor 110 to a control module 240 of the vehicle 100 outside the sensor 110. The control module 240 can use the output signal 232 of the sensor 110 to, for example, make safety-relevant decisions when controlling the vehicle 100, for example, reducing its speed to avoid a collision with the object 215.

If the scanning zone 130 of the sensor 110 is located in the outer region of the vehicle 100, the scanning zone 130 is subject to weather conditions. In the event of an interference due to adverse weather conditions such as fog 140, which is indicated in FIG. 1 and overlays the scanning zone 130, the functionality of the sensor 110 may be restricted.

On the one hand, the transmission signal 212 has a reduced range in fog since a portion of the light emitted by the transmission unit 210 is absorbed by the fog 140. Due to a condensation of fog 140 at a front screen (not shown) of the sensor 110, the range of the transmission signal 212 can furthermore be additionally reduced. The fog 140 can further possibly cause detection losses related to safety-relevant objects 215, i.e. losses that affect the light 222 reflected or remitted by the object 215 and that are reflected in the reception signal 224.

In extreme cases, the sensor 110 can detect the fog 140 instead of the object 215, which can lead to a stopping of the vehicle 100 due to the fog 140. However, at a certain density of the fog 140, the fog 140 can damp the transmission signal 212 without this being recognizable by means of the sensor 110. In such a case, the sensor 110 is possibly no longer able to reliably detect the object 215 within the scanning zone 130.

The above-described difficulties can be avoided or at least mitigated if fog or other adverse weather conditions can be reliably detected in the outer region of the vehicle 100. It is then possible to take suitable measures for operating the sensor and/or the vehicle 100 that allow objects 215 in the outer region of the vehicle 100 to be detected and the vehicle 100 to be controlled accordingly.

The sensor 110 according to the invention is therefore additionally configured for fog recognition. For this purpose, the sensor 110 has a specific scanning layer 150 (cf. FIG. 1) for detecting fog. This specific scanning layer or fog scanning layer 150 forms a partial zone within the scanning zone 130 that differs from the further scanning layers 120, i.e. from the remaining scanning zone 130, by at least one characteristic with respect to the transmission signal 212, with respect to the reception signal 224 and/or with respect to the evaluation of the reception signal 224.

Furthermore, the fog scanning layer 150 is arranged within the scanning zone 130 such that it does not intersect a ground surface 160 on which the vehicle 100 is located. Thus, when the sensor 110 is installed at a predetermined sensor position 170 at the vehicle 100, for example at a bumper at the front side of the vehicle 100, the fog scanning layer 150 thus extends above a horizontal plane that includes the sensor position 170 and extends in parallel with the ground plane 160.

According to the present embodiment, the fog scanning layer 150 differs from the further scanning layers 120 in that a separate transmission element, for example a separate laser or a separate light-emitting diode (LED), is provided for the fog scanning layer within the transmission unit 210 whose transmission signal 212 extends exclusively in the fog scanning layer 150. Alternatively or additionally, the reception unit 220 has a separate reception element for the fog scanning layer 150, for example, a separate APD (avalanche photon diode) or a separate SPAD (single-photon avalanche diode).

Due to the separate transmission and/or reception element within the transmission unit 210 and/or the reception unit 220, the evaluation unit 230 of the sensor 110 is able to distinguish the reception signal 224, which is associated with the fog scanning layer 150 and originates from its plane or area, from the reception signals 224 of the other scanning layers 120. Due to a control signal 234 with which the scanning of the scanning zone 130 is controlled by the transmission signal 212, the evaluation unit 230 further has suitable information as to when the transmission signal 212 scans the fog scanning layer 150. Based on this information alone, it is possible for the evaluation unit 230 to suitably assign the reception signal 224 to the fog scanning layer 150. If the reception unit 220 has a separate reception element for the fog scanning layer 150, this reception element may further have a greater sensitivity than the further reception elements of the reception unit 220. For example, the separate reception element can be provided with a greater gain factor than the further reception elements.

Since the evaluation unit 230 can distinguish the reception signal 224 of the fog scanning layer 150 from the further reception signals 224 of the other scanning layers 120, as explained above, the evaluation unit 230 performs specific evaluation steps that are different from the evaluation steps with which the evaluation unit 230 recognizes or reproduces the contour of the object 215. Based on the reception signal 224 that is associated with the fog scanning layer 150, the evaluation unit 230 thus performs evaluation steps with which the fog 140 within the scanning zone 130 can be detected. The detection of fog, for example, takes place based on resonant circuit signatures. Specific evaluation steps for an optical fog recognition are described, for example, in EP 3 435 117 A1 and EP 3 588 139 A1.

When the evaluation unit 230 of the sensor 110 detects the fog 140 within the scanning zone 130, the evaluation unit 230 outputs specific information or a specific signal within the output signal 232 that is transmitted to the control module 240. For example, the evaluation unit 230 sets a corresponding bit for the detection of the fog 140 within the output signal 232.

The control module 240 then uses the information contained in the output signal 232 regarding the presence of fog 140 within the scanning zone 130 to take suitable control measures. For example, the speed of the vehicle 100 can be reduced and/or the dimensions of a protective field that is considered for the detection of objects 215 in the outer region of the vehicle 100 can be reduced.

Examples of a configuration of such a protective field for the vehicle 100 are described in EP 3 287 809 A1.

The fog 140 is merely one example of possible interference influences on the scanning zone 130 that can attenuate the transmission signal 212 and/or the reception signal 224 due to the absorption or scattering of light.

### REFERENCE NUMERAL LIST

100 vehicle
110 optically scanning sensor
120 scanning layer
121 lowermost scanning layer
122 uppermost scanning layer
130 scanning zone
140 interference influences, fog
150 partial zone of the scanning zone, fog scanning layer
160 ground plane
170 sensor position
210 transmission unit
212 transmission signal
214 scanning within a scanning layer
215 object
220 reception unit
222 light reflected or remitted at the object
224 reception signal
230 evaluation unit
232 output signal
234 control signal
240 control module of the vehicle

1-13. (canceled)

14. An optically scanning sensor, comprising:
a transmission unit for emitting an optical transmission signal into a predetermined scanning zone of the sensor,
a reception unit that is configured to detect a reflected or remitted portion of the transmission signal and to output a corresponding reception signal,
an evaluation unit that is configured to detect at least one object in the scanning zone of the sensor based on the reception signal,
wherein the scanning zone comprises a partial zone that differs from the remaining scanning zone by at least one characteristic with respect to the transmission signal, the reception signal and/or the evaluation of the reception signal, and
wherein the evaluation unit is configured to detect interference influences, which hinder the detection of the object, based on a portion of the reception signal that is associated with the partial zone.

15. The sensor according to claim 14,
wherein the transmission signal covers a predetermined geometric shape within the scanning zone at consecutive points in time, and
the geometric shape covers the partial zone for detecting the interference influences at at least one predetermined point in time.

16. The sensor according to claim 14,
wherein the transmission signal sweeps over the scanning zone in consecutive scanning layers, and
the partial zone is formed by at least one selected scanning layer.

17. The sensor according to claim 16,
wherein the sensor is attached to an apparatus at a sensor position, and
the at least one selected scanning layer that forms the partial zone is arranged above a horizontal plane that comprises the sensor position and extends in parallel with a ground plane on which the apparatus is arranged.

18. The sensor according to claim 14,
wherein a separate transmission element of the transmission unit is associated with the partial zone.

19. The sensor according to claim 14,
wherein a separate reception element of the reception unit is associated with the partial zone.

20. The sensor according to claim 19,
wherein the reception element of the reception unit that is associated with the partial zone has a greater sensitivity than the further reception elements of the reception unit.

21. The sensor according to claim 14,
wherein the evaluation unit is configured to process the reception signal that is associated with the partial zone by means of specific evaluation steps that are different from the evaluation steps with which the evaluation unit processes the reception signal that is associated with the further regions of the scanning zone outside the partial zone.

22. The sensor according to claim 14,
wherein the evaluation unit is configured to receive an additional checking signal and to check the detection of the interference influences based on the checking signal.

23. The sensor according to claim 14,
wherein the sensor is configured as a lidar sensor.

24. The method according to claim 14,
wherein the interference influences comprise fog.

25. Method of using a sensor, comprising:
a transmission unit for emitting an optical transmission signal into a predetermined scanning zone of the sensor,
a reception unit that is configured to detect a reflected or remitted portion of the transmission signal and to output a corresponding reception signal,
an evaluation unit that is configured to detect at least one object in the scanning zone of the sensor based on the reception signal,
wherein the scanning zone comprises a partial zone that differs from the remaining scanning zone by at least one characteristic with respect to the transmission signal, the reception signal and/or the evaluation of the reception signal, and
wherein the evaluation unit is configured to detect interference influences, which hinder the detection of the object, based on a portion of the reception signal that is associated with the partial zone, the method comprising the step of detecting interference influences in the scanning zone of the sensor.

26. The method in accordance with claim 25,
wherein the interference influence is fog.
